(19) United States
(12) Patent Application Publication
(10) Pub. No.: US 2026/0037816 A1
(43) Pub. Date: Feb. 5, 2026

(54) ARTIFICIAL INTELLIGENCE ORCHESTRATION SYSTEM FOR MACHINE LEARNING MODELS

(71) Applicant: INTUIT INC., Mountain View, CA (US)

(72) Inventors: Tin Thanh NGUYEN, San Jose, CA (US); Shankar SANKARARAMAN, Burlingame, CA (US); Qingbo HU, Burlingame, CA (US)

(21) Appl. No.: 18/789,768

(22) Filed: Jul. 31, 2024

(51) Int. Cl. G06N 3/09

(52) U.S. Cl. CPC G06N 3/09

(57) ABSTRACT

Aspects of the present disclosure relate to orchestrating machine learning models. Embodiments include receiving a given set of input features associated with a given user. Embodiments further include providing the given set of input features to an orchestration machine learning model that has been trained to select a plurality of machine learning models based on features associated with users. Embodiments further include aggregating outputs generated by the selected plurality of machine learning models in response to one or more features of the given set of input features.

### INTRODUCTION

Aspects of the present disclosure relate to techniques for orchestrating machine learning models. In particular, techniques described herein involve using an orchestration machine learning model to select machine learning models based on a set of input user features and aggregating the outputs of the selected models using an aggregation machine learning model.

### BACKGROUND

Every year, a growing number of people, businesses, and organizations around the world use machine learning models for performing predictive tasks. For example, a machine learning model may be used to identify content that may be relevant to users of a software application.

Machine learning models may be trained to perform a particular task using data from a particular domain, such as a software application. Because different models may be trained to perform different tasks using different training data, each model may produce unique and useful inferences when presented with a given set of input features. However, orchestrating between various models in a way that effectively utilizes the outputs can pose numerous technical challenges. For example, certain models may have limited usefulness for a particular task (e.g., the task that a model is configured to perform may be irrelevant to the particular task). Providing the input features to a model with limited usefulness for a particular task may result in wasted processing resources (e.g., because the output of the model may be useless for the particular task). Also, aggregating the output of a model with limited usefulness for a task into an output generated for the task may decrease the accuracy of the output for the task. Furthermore, existing rule-based techniques for orchestrating machine learning models may not be flexible enough adjust the orchestration based on the unique characteristics of a given set of input features (e.g., a rule-based orchestration system may include irrelevant model outputs in an aggregated output or fail to adequately measure the relative importance or relevance of the outputs).

Thus, there is a need in the art for improved techniques for orchestrating machine learning models.

### BRIEF SUMMARY

Certain embodiments provide a method of orchestrating machine learning models. The method generally includes: receiving a given set of input features associated with a given user; providing the given set of input features to an orchestration machine learning model that has been trained to select a plurality of machine learning models based on features associated with users; and aggregating outputs generated by the selected plurality of machine learning models in response to one or more features of the given set of input features.

Other embodiments provide processing systems configured to perform the aforementioned method as well as those described herein; non-transitory, computer-readable media comprising instructions that, when executed by one or more processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more embodiments.

### BRIEF DESCRIPTION OF THE DRAWINGS

The appended figures depict certain aspects of the one or more embodiments and are therefore not to be considered limiting of the scope of this disclosure.

FIG. 1 depicts an example of computing components related to orchestrating machine learning models.

FIG. 2 depicts an additional example of computing components related to orchestrating machine learning models.

FIG. 3 depicts example operations related to orchestrating machine learning models.

FIG. 4 depicts an example of a processing system for orchestrating machine learning models.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure provide apparatuses, methods, processing systems, and computer-readable mediums for orchestrating machine learning models.

According to certain embodiments, a set of input features associated with a given user may be provided to an orchestration machine learning model. The orchestration machine learning model may be trained (e.g., through a supervised learning process) to select machine learning models that are relevant to a given set of input features. Based on the input features, the orchestration machine learning model may select a plurality of machine learning models, and the input features may be provided to the plurality of machine learning models. The outputs generated by the plurality of machine learning models in response to the input features may then be aggregated to form an aggregated output. In some embodiments, the aggregation may be performed by an aggregation machine learning model that is trained to aggregate outputs (e.g., based on assigning weights to the outputs).

Certain embodiments provide that a given set of input features associated with a given user may be received. The input features may comprise characteristics of the user such as physical characteristics, financial data, user activity (e.g., clickstream data), and/or the like. As an example, input features for a given user may comprise a list of purchases made by the user with timestamps for each purchase. The input features may also include an indication of a task to be performed (e.g., predicting a service that is relevant to a user).

According to some embodiments, the given set of input features may be provided to an orchestration machine learning model. The orchestration machine learning model may be trained to select machine learning models that are relevant to a particular set of input features. When provided with a set of input features, the orchestration model may output a prediction regarding the relevance of a machine learning model, and the model may be selected (or not selected) based on the prediction. For example, a given set of input features may indicate that a user is a business such as a restaurant. A machine learning model that predicts movies that a user might enjoy may be irrelevant for this user. By contrast, a machine learning model that predicts supplies that a user may be interested in ordering may be highly relevant for this user. As a result, the orchestration model may select the machine learning model that predicts supplies, and the machine learning model that predicts movies may not be selected. In some embodiments, a user may provide an indication of a machine learning model. For example, a user may want to include a particular model in the set of selected models. Based on this indication, the indicated model may be selected.

Certain embodiments provide that the orchestration machine learning model is a graph neural network. Graph neural networks are neural networks that represent data as a graph. For example, each machine learning model that the orchestration model can select may be represented as a node within the graph.

Some embodiments provide that the training for the orchestration model comprises a supervised learning process. The supervised learning process may involve a training data set comprising features associated with a particular user and labels indicating machine learning models that are relevant to the features. For example, the input features for a training data instance may indicate that a user is an individual person, not a business or organization. The input features may indicate a task involving selecting products that may interest the user. The labels may indicate that a machine learning model that predicts tax credits that may be helpful for a business is not relevant. The labels may also indicate that a machine learning model that predicts food items that a user is likely to purchase is relevant. The supervised learning process may comprise iteratively adjusting parameters of the orchestration model until the models predicted as relevant by the orchestration model match the models indicated by the labels.

In some embodiments, the outputs generated by the selected models in response to the input features may be aggregated. Such aggregation may be achieved by combining the outputs of the models (e.g., by averaging the outputs or concatenating the outputs). For example, a first selected machine learning model may be trained to predict products that a user may be interested in purchasing, and a second selected machine learning model may be trained to predict movies that a user may be interested in watching. The first selected model may output a score of 0.7 (which may correspond to a seventy percent confidence) regarding the user's interest in purchasing the movie. The second selected model may output a score of 0.8 regarding the user's interest in watching the movie. The aggregation may comprise averaging the scores (resulting in a score of 0.75 for the user's interest in the movie), selecting the maximum score (e.g., 0.8), selecting the minimum score (e.g., 0.7), and/or the like. As another example, a first selected machine learning model may be trained to predict state tax credits that are relevant for a user, and a second selected machine learning model may be trained to predict federal tax credits that are relevant for the user. The outputs of these models may be combined (e.g., concatenated) such that both predictions are presented to the user.

According to certain embodiments, the aggregating may be performed by an aggregation machine learning model. The aggregation machine learning model may be trained to aggregate the outputs of various machine learning models into a single output. For example, the training may comprise a supervised learning process involving training data that includes a set of machine learning model outputs (which may also include an indication of the machine learning model) with a ground-truth aggregated output. The set of outputs may be provided to the aggregation model and one or more parameters of the aggregation model may be iteratively adjusted based on comparing outputs of the aggregation model to the ground-truth output over a series of iterations. Because the machine learning model outputs provided as input to the aggregation model are all based on the input features, the aggregation model may aggregate the scores without being provided with the input features. Aggregating the outputs without directly providing the input features as input to the aggregation model may save time and computing resources (e.g., because fewer features will be processed by the aggregation model). However, in some embodiments, the aggregation model may be trained using input features, and may aggregate the outputs based on the features that were provided as inputs to the models that produced the outputs. Aggregating the outputs based on the input features may lead to increased accuracy with the tradeoff of less efficiency.

Some embodiments provide that one or more tasks may be performed based on the aggregated outputs. For example, the aggregated output may be provided to a user via a user interface. The aggregated output may be used to generate a response to a request, such as by providing the aggregated output as input to a generative machine learning model. Other types of content may be generated based on the aggregated output, one or more values (e.g., values associated with a model or a set of data) may be modified based on the aggregated output, and/or similar tasks may be performed.

Embodiments of the present disclosure provide numerous technical and practical effects and benefits. For example, techniques described herein allow for automatically selecting machine learning models that are relevant for a particular task (and omitting models that are not relevant) based on input features associated with a user. While existing techniques for orchestrating the use of multiple machine learning models generally involve rules-based model selection, techniques described herein provide a more dynamic, flexible, and targeted orchestration process through the use of a trained orchestration machine learning model, thereby producing improved results such as the selection of models that are more relevant and effective for particular tasks. Thus, techniques described herein enable a software application to more effectively perform tasks that involve the use of machine learning models, such as presenting recommended content to a user via the user interface, generating a response to a request from a user, and/or the like. Additionally, embodiments of the present disclosure provide for automatically aggregating the outputs of the selected models using a machine learning model that is trained to generate an aggregated output based on multiple outputs. This aggregated output may be more accurate and reliable than the output of any particular model because it is based on the combined knowledge of several models. Also, the aggregated output may be automatically obtained by providing the input features to a single endpoint (e.g., the orchestration machine learning model), as opposed to providing the features to multiple endpoints corresponding to multiple machine learning models, thereby improving application efficiency and simplicity. Thus, embodiments of the present disclosure simultaneously simplify machine learning technologies (e.g., by automatically orchestrating between multiple machine learning models based on inputs provided to a single endpoint) as well as simplify software application development (e.g., by enabling a developer to utilize a single endpoint to achieve a machine learning task instead of requiring the developer to understand, choose between, and/or interact with multiple machine learning models in application code), while increasing the power of said machine learning technologies (e.g., by allowing for the aggregation of outputs from multiple relevant models). Additionally, by selecting relevant and useful machine learning models for a particular task with a higher level of accuracy based on particular machine learning based orchestration techniques, embodiments of the present disclosure avoid the unnecessary utilization of computing resources that would otherwise occur in connection with using irrelevant or suboptimal machine learning models for the particular task.

### Example of Computing Components Related to Orchestrating Machine Learning Models

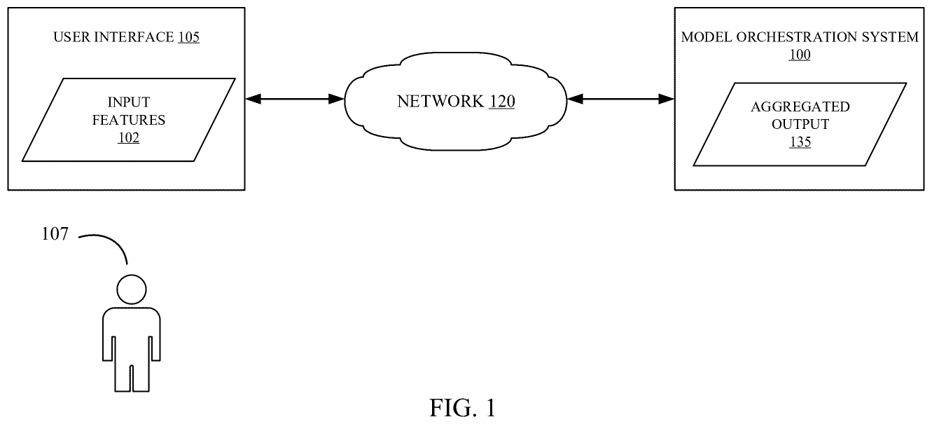

FIG. 1 depicts an example of computing components related to orchestrating machine learning models.

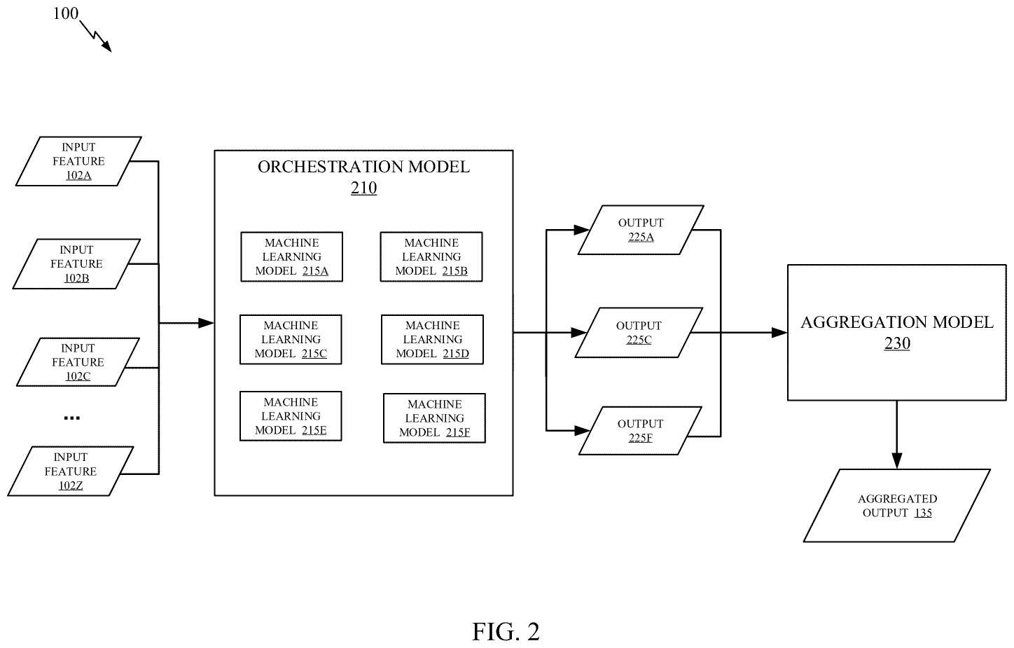

A user 107 of a software application may use a user interface 105 to interact with the software application. The software application may collect input features, such as information associated with the user 107 (e.g., clickstream data, transaction data, personal or identifying attributes of the user, and/or the like) and an indication of a task to be performed (e.g., the indication may be a request from the application for a recommendation regarding which advertisements to show to the user 107). The input features 102 may be sent to a model orchestration system 100 over a network 120. As described in further detail below with respect to FIG. 2, model orchestration system 100 may orchestrate multiple machine learning models and aggregate the outputs of the models to generate an aggregated output 135 based on the input features 102.

The aggregated output 135 may be sent to the application over the network 120. The application may use the aggregated output 135 to perform a task (e.g., presenting recommended content to the user 107 via the user interface 105, generating a response to a request from the user 107, and/or the like).

FIG. 2 depicts an additional example of computing components related to orchestrating machine learning models. In particular, FIG. 2 depicts model orchestration system 100 of FIG. 1 in greater detail.

An orchestration model 210 may comprise a machine learning model, such as a graph neural network. The orchestration model 210 may be trained to select a plurality of machine learning models of a set of machine learning models 215A-F based on the input features 102A-Z. Each of the machine learning models 215A-F may be represented as nodes within the graph neural network or as nodes within another type of machine learning model that is used as the orchestration model 210.

The orchestration model 210 may be trained through a supervised learning process to identify machine learning models based on input features. Supervised learning techniques generally involve providing training inputs to a machine learning model. The machine learning model processes the training inputs and outputs predictions based on the training inputs. The predictions are compared to the known labels associated with the training inputs to determine the accuracy of the machine learning model, and parameters of the machine learning model are iteratively adjusted until one or more conditions are met. For instance, the one or more conditions may relate to an objective function (e.g., a cost function or loss function) for optimizing one or more variables (e.g., model accuracy). In some embodiments, the conditions may relate to whether the predictions produced by the machine learning model based on the training inputs match the known labels associated with the training inputs or whether a measure of error between training iterations is not decreasing or not decreasing more than a threshold amount. The conditions may also include whether a training iteration limit has been reached. Parameters adjusted during training may include, for example, hyperparameters, values related to numbers of iterations, weights, functions used by nodes to calculate scores, and/or the like. In some embodiments, validation and testing are also performed for a machine learning model, such as based on validation data and test data, as is known in the art.

The supervised learning process for orchestration model 210 may involve a training data set comprising features associated with a particular user and labels indicating machine learning models that are relevant to the features. For example, the input features for a training data instance may indicate a task to be performed and characteristics of a user. The labels may indicate machine learning models that are relevant and machine learning models that are not relevant based on the user characteristics and the indicated task (e.g., such labels may be generated based on input from a user, such as an expert on available machine learning models). In some embodiments, the labels may indicate characteristics of machine learning models that are relevant and machine learning models that are not relevant based on the user characteristics and the indicated task (e.g., labels may include characteristics of the models, such as a model type, architecture, textual description, number of parameters, output type(s), input type(s), and/or the like rather than directly identifying the models). The supervised learning process may comprise iteratively adjusting parameters of the orchestration model 210 based on comparing the models predicted as relevant by the orchestration model 210 to the models indicated by the labels, such as using a cost function and/or otherwise based on whether the predictions match the labels or are within a threshold amount of similarity to the labels.

A plurality of input features 102A-Z may be provided to the orchestration model 210. The input features 102A-Z may be associated with a user of a software application. The input features 102A-Z may comprise characteristics of the user such as physical characteristics, financial data, user activity (e.g., clickstream data), and/or the like. The input features may also include an indication of a task to be performed. As an example, input feature 102A may indicate a task to be performed. For instance, input feature 102A may be a request from an application for model orchestration system 100 to predict a set of income tax credits for which a user is eligible. Continuing the example, input features 102B-Z may include user characteristics, such as items the user has purchased, information the user has provided (e.g., financial information), clickstream data, whether the user is an individual or an organization, and/or the like.

Based on the input features 102A-Z, orchestration model may identify one or more models of machine learning models 215A-F that are relevant to the user and task. Each of machine learning models 215A-F may be models that are trained using a different set of training data and/or trained to perform different (although, in some cases similar) tasks. The machine learning models 215A-F may be different types of models (e.g., one model may be a recurrent neural network and another model may be a convolutional neural network) or different versions of the same model (e.g., trained with different training data, different training algorithms, and/or to perform different tasks). Continuing the above example, machine learning model 215A may be a model that is trained to recommend federal income tax credits for individuals based on purchase history. The input features 102A-Z may indicate that this model is relevant to the task of predicting a set of income tax credits for which a user is eligible, and machine learning model 215A may be selected based on the indication. Machine learning model 215B may be a model that is trained to recommend federal income tax credits for businesses based on features of the business. The input features 102A-Z may indicate that this model is not relevant to the task (e.g., because the user is not a business and does not own a business), and machine learning model 215B may not be selected based on the indication. In some embodiments, a user may provide an indication of a model that is to be selected, and the selection may be made based on this indication (e.g., the indicated model may be a model that the user wants to be selected).

Machine learning model 215C may be a model that is trained to recommend state income tax credits for individuals from the state of California based on purchase history. The input features 102A-Z may indicate that this model is relevant to the task (e.g., because the user is from California), and machine learning model 215C may be selected based on the indication. Machine learning model 215D may be a model that is trained to recommend state income tax credits for individuals from the state of New York based on purchase history. The input features 102A-Z may indicate that this model is not relevant to the task (e.g., because the user is not from New York), and machine learning model 215D may not be selected based on the indication.

Machine learning model 215E may be a model that is trained to recommend federal income tax credits for individuals based on business expenses incurred by the individual. The input features 102A-Z may indicate that this model is not relevant to the task (e.g., because the user did not have any business expenses), and machine learning model 215E may not be selected based on the indication. Machine learning model 215F may be a model that is trained to recommend federal income tax deductions and credits for individuals based on childcare expenses incurred by the individual. The input features 102A-Z may indicate that this model is relevant to the task (e.g., because the user has children), and machine learning model 215F may be selected based on the indication.

One or more of the input features 102A-Z may be provided to the machine learning models that are selected by the orchestration model 210. Continuing the above example, input feature 102C may comprise data regarding a childcare purchase that a user made. Input feature 102C may be provided to machine learning model 215F, and machine learning model 215F may generate an output 225F based on input feature 102C. The output may be a prediction as to whether the user may be eligible for a childcare tax credit based on the purchase indicated by input feature 102C. Outputs 225A and 225C may be outputs from selected machine learning models 215A and 215C respectively.

The outputs of the selected machine learning models may be provided to aggregation model 230. The aggregation model 230 may comprise a machine learning model that is trained to aggregate the outputs of various machine learning models into a single aggregated output 135. The aggregation may comprise combining outputs, synthesizing outputs, concatenating outputs, and or the like. For example, outputs 225A, 225C, and 225F may each be probabilities that a user will purchase a particular item. Aggregation model 230 may use these three probabilities to generate a single probability of the user purchasing the item. As another example, outputs 225A and 225C may be probabilities that a user is eligible for a first tax deduction and output 225F may be a probability that the user is eligible for a second tax deduction. Outputs 225A and 225C may be combined into a single probability that the user is eligible for the first tax deduction. The aggregated output 135 may comprise both the single probability that the user is eligible for the first tax deduction and the probability that the user is eligible for the second tax deduction. Thus, the user may receive indications of whether the user is eligible for the first and second tax deductions. In some embodiments the aggregation may be achieved without the use of a machine learning model (e.g., the outputs may be averaged to form the aggregated output 135). In some embodiments, aggregation of outputs may be weighted, such as based on confidence scores output by one or more machine learning models 215 in association with the outputs that are being aggregated. For example, confidence scores associated with outputs 225A, 225B, and 225C may be provided along with outputs 225A, 225B, and 225C to aggregation model 230, and these confidence scores may be used by aggregation model 230 in generating aggregated output 135.

The training process for aggregation model 230 may comprise a supervised learning process involving training data that includes a set of machine learning model outputs (which may also include an indication of the machine learning model) with a ground-truth aggregated output. The set of outputs may be provided to the aggregation model and one or more parameters of the aggregation model may be iteratively adjusted based on comparing an output of the aggregation model to the ground-truth output, such as using a cost function and/or otherwise based on whether the output matches or is within a threshold amount of similarity to the ground-truth output. In some embodiments, the aggregation model 230 may be trained using input features, such as input features 102A-Z. The aggregation model 230 may aggregate the outputs based on the input features 102A-Z.

### Example Operations Related to Orchestrating Machine Learning Models

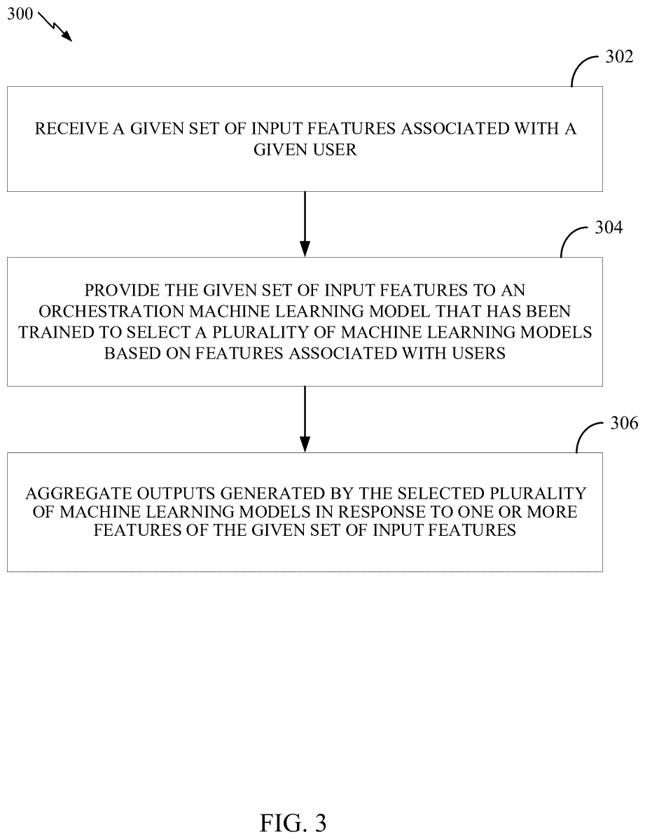

FIG. 3 depicts example operations 300 related to orchestrating machine learning models. For example, operations 300 may be performed by one or more of the components described with respect to FIG. 1 and FIG. 2.

Operations 300 begin at step 302 with receiving a given set of input features associated with a given user.

Operations 300 continue at step 304 with providing the given set of input features to an orchestration machine learning model that has been trained to select a plurality of machine learning models based on features associated with users. In some embodiments, the orchestration machine learning model is trained through a supervised learning process involving a training data set comprising respective features associated with a particular user and labels indicating machine learning models that are relevant based on the respective features. Some embodiments provide that the orchestration machine learning model comprises a graph neural network. According to certain embodiments, each of the plurality of machine learning models is represented as a node in the orchestration model. In certain embodiments, the plurality of machine learning models are selected based on an indication of a machine learning model received from a user. In some embodiments, each of the plurality of machine learning models is trained using a different training data set. According to some embodiments, each of the plurality of machine learning models is trained to perform a different task.

Operations 300 continue at step 306 with aggregating outputs generated by the selected plurality of machine learning models in response to one or more features of the given set of input features. Certain embodiments provide that the aggregating is performed using an aggregation machine learning model that is trained to generate an aggregated score based on the outputs of the selected plurality of machine learning models. According to some embodiments, the aggregation machine learning model is trained through a supervised learning process involving a training data set comprising outputs of a multitude of machine learning models and labels indicating an aggregated score based on the outputs of the multitude of machine learning models. In certain embodiments, the training data set for the aggregation model further comprises features associated with a particular user.

In some embodiments, the method further comprises performing, based on the aggregating of the outputs, one or more of: generating a response to a request; displaying information via a user interface; modifying one or more values; or generating content.

### Example of a Processing System for Orchestrating Machine Learning Models

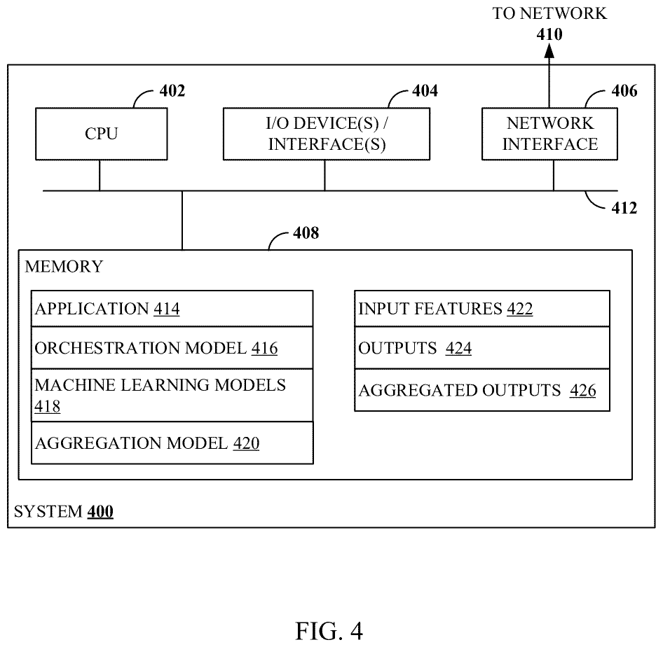

FIG. 4 illustrates an example system 400 with which embodiments of the present disclosure may be implemented. For example, system 400 may be configured to perform operations 300 of FIG. 3 and/or to implement one or more components as in FIG. 1 or FIG. 2.

System 400 includes a central processing unit (CPU) 402, one or more I/O device interfaces that may allow for the connection of various I/O devices 404 (e.g., keyboards, displays, mouse devices, pen input, etc.) to the system 400, network interface 406, a memory 408, and an interconnect 412. It is contemplated that one or more components of system 400 may be located remotely and accessed via a network 410. It is further contemplated that one or more components of system 400 may comprise physical components or virtualized components.

CPU 402 may retrieve and execute programming instructions stored in the memory 408. Similarly, the CPU 402 may retrieve and store application data residing in the memory 408. The interconnect 412 transmits programming instructions and application data, among the CPU 402, I/O device interface 404, network interface 406, and memory 408. CPU 402 is included to be representative of a single CPU, multiple CPUs, a single CPU having multiple processing cores, and other arrangements.

Additionally, the memory 408 is included to be representative of a random access memory or the like. In some embodiments, memory 408 may comprise a disk drive, solid state drive, or a collection of storage devices distributed across multiple storage systems. Although shown as a single unit, the memory 408 may be a combination of fixed and/or removable storage devices, such as fixed disc drives, removable memory cards or optical storage, network attached storage (NAS), or a storage area-network (SAN).

As shown, memory 408 includes application 414, orchestration model 416, machine learning models 418, and aggregation model 420. In some embodiments, application 414 may be representative of a software application associated with user interface 105 of FIG. 1, and may perform various aspects of functionality described herein. Orchestration model 416 may be representative of orchestration model 210 of FIG. 2. Machine learning models 418 may be fraud machine learning models 215A-F of FIG. 2. Aggregation model 420 may be representative of aggregation model 230 of FIG. 2.

Memory 408 further comprises input features 422 which may correspond to input features 102 of FIG. 1 and FIG. 2. Memory 408 further comprises outputs 424, which may correspond to outputs 225A, 225C, and 225F of FIG. 2. Memory 408 further comprises aggregated outputs 426, which may correspond to aggregated output 135 of FIG. 1 and FIG. 2. It is noted that in some embodiments, system 400 may interact with one or more external components, such as via network 410, in order to retrieve data and/or perform operations.

### Additional Considerations

The preceding description provides examples, and is not limiting of the scope, applicability, or embodiments set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The preceding description is provided to enable any person skilled in the art to practice the various embodiments described herein. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and other operations. Also, “determining” may include receiving (e.g., receiving information), accessing (e.g., accessing data in a memory) and other operations. Also, “determining” may include resolving, selecting, choosing, establishing and other operations.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

A processing system may be implemented with a bus architecture. The bus may include any number of interconnecting buses and bridges depending on the specific application of the processing system and the overall design constraints. The bus may link together various circuits including a processor, machine-readable media, and input/output devices, among others. A user interface (e.g., keypad, display, mouse, joystick, etc.) may also be connected to the bus. The bus may also link various other circuits such as timing sources, peripherals, voltage regulators, power management circuits, and other types of circuits, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer-readable medium. Software shall be construed broadly to mean instructions, data, or any combination thereof, whether referred to as software, firmware, middleware, microcode, hardware description language, or otherwise. Computer-readable media include both computer storage media and communication media, such as any medium that facilitates transfer of a computer program from one place to another. The processor may be responsible for managing the bus and general processing, including the execution of software modules stored on the computer-readable storage media. A computer-readable storage medium may be coupled to a processor such that the processor can read information from, and write information to, the storage medium. In the alternative, the storage medium may be integral to the processor. By way of example, the computer-readable media may include a transmission line, a carrier wave modulated by data, and/or a computer readable storage medium with instructions stored thereon separate from the wireless node, all of which may be accessed by the processor through the bus interface. Alternatively, or in addition, the computer-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module, it will be understood that such functionality is implemented by the processor when executing instructions from that software module.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method of orchestrating machine learning models, comprising:
receiving a given set of input features associated with a given user;
providing the given set of input features to an orchestration machine learning model that has been trained to select a plurality of machine learning models based on features associated with users; and
aggregating outputs generated by the selected plurality of machine learning models in response to one or more features of the given set of input features.

2. The method of claim 1, wherein the orchestration machine learning model is trained through a supervised learning process involving a training data set comprising respective features associated with a particular user and labels indicating machine learning models that are relevant based on the respective features.

3. The method of claim 1, wherein the aggregating is performed using an aggregation machine learning model that is trained to generate an aggregated score based on the outputs of the selected plurality of machine learning models.

4. The method of claim 3, wherein the aggregation machine learning model is trained through a supervised learning process involving a training data set comprising outputs of a multitude of machine learning models and labels indicating an aggregated score based on the outputs of the multitude of machine learning models.

5. The method of claim 4, wherein the training data set further comprises features associated with a particular user.

6. The method of claim 1, wherein the orchestration machine learning model comprises a graph neural network.

7. The method of claim 1, wherein each of the plurality of machine learning models is represented as a node in the orchestration machine learning model.

8. The method of claim 1, further comprising receiving an indication of a machine learning model from a user, wherein the plurality of machine learning models are selected based on the indication.

9. The method of claim 1, wherein each of the plurality of machine learning models is trained using a different training data set.

10. The method of claim 1, wherein each of the plurality of machine learning models is trained to perform a different task.

11. The method of claim 1, further comprising performing, based on the aggregating of the outputs, one or more of:
generating a response to a request;
displaying information via a user interface;
modifying one or more values; or
generating content.

12. A system for orchestrating machine learning models, comprising:
one or more processors; and
a memory comprising instructions that, when executed by the one or more processors, cause the system to:
receive a given set of input features associated with a given user;
provide the given set of input features to an orchestration machine learning model that has been trained to select a plurality of machine learning models based on features associated with users; and
aggregate outputs generated by the selected plurality of machine learning models in response to one or more features of the given set of input features.

13. The system of claim 12, wherein the orchestration machine learning model is trained through a supervised learning process involving a training data set comprising respective features associated with a particular user and labels indicating machine learning models that are relevant based on the respective features.

14. The system of claim 12, wherein the aggregating is performed using an aggregation machine learning model that is trained to generate an aggregated score based on the outputs of the selected plurality of machine learning models.

15. The system of claim 14, wherein the aggregation machine learning model is trained through a supervised learning process involving a training data set comprising outputs of a multitude of machine learning models and labels indicating an aggregated score based on the outputs of the multitude of machine learning models.

16. The system of claim 15, wherein the training data set further comprises features associated with a particular user.

17. The system of claim 12, wherein the orchestration machine learning model comprises a graph neural network.

18. The system of claim 12, wherein each of the plurality of machine learning models is represented as a node in the orchestration machine learning model.

19. The system of claim 12, further comprising receiving an indication of a machine learning model from a user, wherein the plurality of machine learning models are selected based on the indication.

20. The system of claim 12, wherein the instructions further cause the system to perform, based on the aggregating of the outputs, one or more of:
generating a response to a request;
displaying information via a user interface;
modifying one or more values; or
generating content.
